(19) United States
(12) Patent Application Publication
(10) Pub. No.: US 2011/0112934 A1
(43) Pub. Date: May 12, 2011

(54) SENSORY THREE-DIMENSIONAL VIRTUAL REAL SPACE SYSTEM

(76) Inventor: Junichi Ishihara, Fukushima (JP)

(21) Appl. No.: 12/737,121

(22) PCT Filed: Jun. 9, 2009
(86) PCT No.: PCT/JP2009/060813

§ 371 Date: Dec. 9, 2010

(30) Foreign Application Priority Data
Jun. 10, 2008 (JP) 2008-151359

(51) Int. Cl. G06Q 30/00; G06F 3/14; G09G 5/00

(52) U.S. Cl. 705/27.1; 715/782; 715/716; 345/633

(57) ABSTRACT

The inside of a three-dimensional virtual real space so constituted as to have a real size according to the figure and five senses (auditory sense, visual sense, and so forth) of the user can be continuously used like the real living space. A sensory three-dimensional virtual real space system includes a body hardware server device (1), a dedicated program software application (2) which is a three-dimensional virtual real program inserted or downloaded into the body hardware server device (1) so as to be installable in the body hardware server device (1), and a user-dedicated device (3) connected to the body hardware server device (1) so as to wirelessly communicate with the body hardware server device (1) in real time, wearable by the user, and enabling the user to experience a three-dimensional virtual real space according to the three-dimensional virtual real program. The user-dedicated device (3) converts three-dimensionally converted data in the three-dimensional virtual real program into a four-dimensional time-space which can be so constituted to have a real size adapted to the figure and the five senses of the user, contains elements such as sounds, light, and shadows in the program coordinate system, and is continuously variable by the action of the user.

### TECHNICAL FIELD

The present invention relates to a sensory three-dimensional virtual real space system which allows to recognize a space in a real size according to a user's figure, five senses including auditory sense and visual sense, thus enabling to own or jointly own a private space or a public space and use various contents by a life-sized module, whereby a user can sense a temporal module unique to the user as a four-dimensional time-space.

### BACKGROUND ART

The conventional virtual space system has been expressed through a two-dimensional (planar) viewpoint as disclosed in Patent Document 1, and an image has been confirmed by using a planar monitor as a method of expression of a three-dimensional space image. Moreover, the view has been spread within a monitor ahead of the user, and the vision has been apt to be reduced in inverse proportion to a distance from the monitor. Moreover, the conventional virtual space has not reacted to a user's motion or viewpoint, but relied on a terminal operation such as mouse operation or keyboard operation. That is, operating a user's viewpoint using fingers, not a body or a head, has been the mainstream.
Patent Document 1: Japanese Patent Application Laid-Open No. 2002-245294

### DISCLOSURE OF INVENTION

### Problems to be Solved by the Invention

The conventional virtual space has had no continuity or dependency, and the private space has not been handled as an actually owned space but recognized as seeing a space owned (created) by a third party.

In the conventional virtual space, the view has been spread within a monitor ahead of the user, and the visual field has been apt to be reduced in inverse proportion to a distance from the monitor, which cannot provide space recognition in a real size of a sense of distance, size, etc. Moreover, a borderline between a real space and a virtual space has been unclear since the conventional virtual space has not corresponded to three-dimensional actions of a user including up and down, left and right, and front and back actions.

Moreover, conventional virtual spaces have not clearly reproduced four-dimensional (spatiotemporal) modules within virtual spaces. In other words, time in four-dimensional time-space refers to a sensory time that a user perceives, and it must constantly move; however, virtual time in conventional virtual spaces can be freely set according to each user's taste regardless of consistency with the real time, and has not had continuity.

Accordingly, the present invention has been made in light of the existing circumstances mentioned above, aiming at providing a sensory three-dimensional virtual real space system with life-sized modules, enabling to use the inside of the three-dimensional virtual space, so constituted as to have a life size adapted to a user's figure and five senses (auditory sense, visual sense, and so forth), as a private space which only the user can continuously use like a real living space.

### Means for Solving the Problems

In order to achieve the above object, a sensory three-dimensional virtual real space system of the present invention includes: a body hardware server device; a three-dimensional virtual real program inserted or downloaded into the body hardware server device; and a user-dedicated device which can be worn by, carried by, or installed near a user while integrally connected, wired, or wirelessly connected with the body hardware server device such that an operating range and degree of freedom increase to enable real-time recognition or transmission and reception, thus enabling the user to experience a three-dimensional virtual real space based on the three-dimensional virtual real program, wherein the body hardware server device or the user-dedicated device can convert three-dimensionally converted data in the three-dimensional virtual real program into a four-dimensional time-space including up and down, left and right, front and back, and time, which can be constituted by real modules adapted to the user's figure and five senses and contains elements of five senses such as sounds, light, shadows, scent, gas, temperature and humidity in a program coordinate system, and the three-dimensional virtual real space is continuously variable according to the action of the user.

Further, the body hardware server device or the user-dedicated device can configure and represent the three-dimensional virtual real space, which is exactly the same as the space of actual modules.

Further, the body hardware server device or the user-dedicated device enables touch with real animals including human beings, virtual animals including human beings, real objects, and virtual objects including liquid, gas, particles, and quantum body in the virtual real space, and enables a user's viewpoint to change to a viewpoint of virtual animals including human beings, virtual objects including liquid, gas, particles, and quantum body, real animals including a life-sized human beings as a module, and real objects.

Further, the body hardware server device or the user-dedicated device is provided with a three-dimensional scanner which can show the real animals and objects as life-sized modules other than the virtual animals and objects in the virtual real space, and can fetch scanned three-dimensional information in the virtual real space, and enables recognition of changes of movement and conditions as three-dimensional information in real time.

Further, the body hardware server device or the user-dedicated device is provided with a communication unit that can transmit and receive three-dimensional data of the virtual animals and objects and information data between users.

Further, the body hardware server device or the user-dedicated device is provided with a caption converting and displaying function, a function of voice synthesis program, etc. or a language dubbing function in order to match a language used in a three-dimensional virtual real space with a language used among users.

Further, the body hardware server device or the user-dedicated device can respond to and operate with user operations through a voice or typing input in a three-dimensional virtual real space, is compatible with various authentication operations using vocal cord authentication in the three-dimensional virtual real space, and is provided with authentication functions including fingerprint and retina authentication using other dedicated devices when the voice authentication is unavailable, thus enabling various security countermeasures.

Further, the body hardware server device or the user-dedicated device allows a plurality of users to participate in the three-dimensional virtual real space and to jointly own respective three-dimensional virtual real spaces owned by the plurality of users as a result of installation of these devices.

Further, the body hardware server device or the user-dedicated device can be used as a mobile communication device and thus freely carried by a user, used anywhere in communication coverage areas, and can be integrated with each other so as to be formed in a handy shape as a unitary device and installed in a narrow space, thus enabling communication among users anywhere.

Further, the body hardware server device or the user-dedicated device can be used in an in-house power generation system using power supply other than public power supply, photovoltaic generation or fuel cells, etc.

Further, the body hardware server device or the user-dedicated device enables purchase and sale as well as dealing of virtual goods and various types of virtual data or rights such as virtual immovable properties in the three-dimensional virtual real space, enables purchase and sale as well as dealing of real data, rights and goods, etc., enables use of real currency and credits in various forms of dealing, and enables use of virtual currency or credits in a virtual bank, etc., and enables use of settlement in a legally authorized form, thus enabling settlement in the virtual real space unique to a user.

Further, the body hardware server device or the user-dedicated device can show its viewing range which is the same as that of a human's view angle, thus enabling display of a 360-degree panorama space using movement of the body, head, and eyes.

Further, the dedicated program as the three-dimensional virtual real program can prevent duplication and virus contamination, protect copyright of a person who has prepared a program software, and protect rights such as ownership of an owner of the three-dimensional virtual real program software.

Further, the three-dimensional virtual real space can be structured as a life-sized module, and thus virtual actions can be linked with a real robot, etc. by replacing real material with that in virtual space, thereby enabling actions in the three-dimensional virtual real space to be directly linked with those in the real space.

### EFFECT OF THE INVENTION

The present invention can provide a sensory three-dimensional virtual real space system as a life-sized module which allows to recognize a space in a real size according to a user's figure and five senses including auditory sense and visual sense, and recognize the space similarly to an actual real space, thus enabling to own or use a private space which only the user can use continuously or dependently. Additionally, depending upon its use, variation of form of connecting the device and variation of method of use unique to users of the device may be added, which alleviates the restriction on environment of the usage and increases degree of freedom.

More specifically, the invention can provide a sensory three-dimensional virtual real space system as a life-sized module which includes a body hardware server device, a dedicated program software which is inserted or downloaded into the body hardware server device, enabling a three-dimensional virtual real program to be installed in the body hardware server device, and a user-dedicated device which can be worn by a user while connected wirelessly with the body hardware server device so as to enable real-time transmission and reception, thus enabling the user to experience a three-dimensional virtual real space based on the three-dimensional virtual real program, wherein the user-dedicated device can convert three-dimensionally converted data in the three-dimensional virtual real program into a four-dimensional time-space including up and down, left and right, front and back, and time, which can be so constituted as to have a life size adapted to the user's figure and five senses and contains elements such as sounds, light, shadows on the program coordinate, and the three-dimensional virtual real space is continuously variable according to the action of the user, enabling to use the inside of the three-dimensional virtual real space as a private space which only the user can continuously use like a real living space.

The body hardware server device or the user-dedicated device can constitute the three-dimensional virtual real space having completely the same distance and size as those of the real objects, facilitating users' spatial recognition of a sense of distance and size, etc. in a real size. At the same time, a fusion of the communication network program and the four-dimensional panoramic spatial program in the package software also helps users easily recognize the three-dimensional virtual real space as another private space. In addition, the body hardware server device and the user-dedicated device provide virtual bodily experience similar to the real bodily sense, facilitating construction of a system that can easily reproduce the realism of distance, texture, sound, and other elements.

Accordingly, as the inside of this three-dimensional virtual real space under this system is constituted as the life-sized module, objects and structures, distance, height, length, width, and other elements that actually exist in the real space can be linked to the real space. Remote control of actions in the virtual reality is also possible by using robots or other devices in the real space.

The body hardware server device and the user-dedicated device are each equipped with processing capability, aiming at constituting more comfortably and providing the sensory three-dimensional virtual real space system to users. These devices can also separately constitute a three-dimensional virtual real space and can be handled as a unitary device.

The body hardware server device or the user-dedicated device can switch the viewpoint of animals and objects other than a user himself/herself in the three-dimensional virtual real space. This allows the user to experience various visual effects that are not available in reality and conceive various applications of the system. So-called visual simulation is also enabled. As a result, the system can be applied in a diverse range of industries.

The body hardware server device or the user-dedicated device is equipped with a three-dimensional scanner to scan the state of life-sized modules such as real animals and objects including the user, and constantly transmits and receives the three-dimensional information to/from the three-dimensional virtual real space program. However, the body hardware server device and the user-dedicated device, when working as a unitary device, may fail to sufficiently recognize actions of operations, possibly causing inaccuracy in scanning results. If real-time information can be transmitted and received more rapidly by sharing operations by scanners each of which can perform scanning operations, actions in the three-dimensional virtual real space can be performed more smoothly. Operations as a unitary device can also performed.

Moreover, the body hardware server device or the user-dedicated device needs to transmit and receive information on a real-time basis; otherwise the actions in the three-dimensional virtual real space may not be performed correctly. Accordingly, communication means is essential for these devices. If each device has communication means separately, or if they share the communication means, this can help determination of priorities in transmission and reception and early acquisition of required information. Information can be transmitted/received by each device as a unitary device. However, when a fluctuation occurs due to transmission and reception conditions, the shared transmission and reception processes performed by these devices can provide a three-dimensional virtual real space that is comfortable for the users on both ends, by compensating delays in information transmission/reception between them.

Users of the body hardware server device or the user-dedicated device may communicate with other users or the like in different languages in the three-dimensional virtual real space. It is, however, difficult to master all of these languages, and this may spoil the user-friendliness of the system. Therefore, the system is equipped with a caption converting function or dubbing function to convert the language used in the three-dimensional virtual real space to each user's language, which enables a real-time linguistic conversion using pre-programmed voice synthesis and translation programs, in order to help users understand in their own language. This function allows virtual global communication and greatly contributes to expansion of communication ranges and business opportunities.

The body hardware server device or the user-dedicated device has been originally intended to recognize user operation by his/her figure or action in the three-dimensional virtual real space. However, physically-handicapped users may not perform a series of actions. To enhance adaptability to various situations and environments, the system is equipped with speech- and type-recognition programs, enabling the use by those who cannot perform predefined body actions. From the viewpoint of security, various authentication methods are employed; the system adopts fingerprint authentication, retina authentication, and vocal cord authentication to ensure safety of the three-dimensional virtual real space since various authenticating operations are expected.

In addition, when a plurality of body hardware server devices or user-dedicated devices are installed, a plurality of users can participate in the three-dimensional virtual real space, and devices can be jointly owned by using a common program of three-dimensional virtual real space systems owned by the plurality of users. Participation of the plurality of users in the three-dimensional virtual real space can provide the opportunities of communication including information exchange and business communication. Various types of communication means including a network or the Internet are available, and under various environments, communication in a space with security is realized. Moreover, more friendly and global communication which is different from a television-phone can be realized under the unique three-dimensional virtual real space, which has not been realized before.

The conventional three-dimensional virtual real spaces have been mainly used in a large-scale facilities or building. However, to conduct communication or continually and dependently utilize the three-dimensional virtual real space, the three-dimensional virtual real space should be experienced in any area where communication can be made. To make the three-dimensional virtual real space available anywhere, mobility is indispensable. For this reason, to add mobility to a relatively large device or plural devices, the body hardware server device or the user-dedicated device of the present invention is designed to be compact and features a shape that a user can easily hold. Moreover, these devices are integrated, and necessary accessories are designed to have a compact size, which enables the devices to be carried and used under various environments.

An object of the present invention is to make the three-dimensional virtual real space system usable continually and dependently. To do so, a close relation with a user under various environments is indispensable. If an energy problem, especially a power supply problem, occurs in case of emergency, some measures must be taken; otherwise, the system is obviously useless. The present invention supports energy sources, especially power supply, thus enabling to support various power supply means.

Moreover, another object of the present invention is that the body hardware server device or the user-dedicated device regards business dealings in the three-dimensional virtual real space as unique ones. Although such dealings differ from user's vision of the world, this is a means for seeking for usability through linking them with real dealings. However, dealing methods similar to real ones should be usable since market or financial confusion could occur if dealing methods remarkably different from real ones are employed. Nevertheless, original dealings can be established in the three-dimensional virtual real space by means of providing original currency, prices, currency exchanges, and securities in the three-dimensional virtual real space in order to establish an original view of the world in the three-dimensional virtual real space. These features strengthen user's values of the three-dimensional virtual real space, and enable the continual and dependent use of the system, which is one of the objects of the present invention. Through these features, it is possible to establish the three-dimensional virtual real space as a virtual country, and a user can freely use the space complying with rules of the virtual country, which can be applied for the industrial use.

The body hardware server device or the user-dedicated device can show almost the same viewing ranges as the ranges of about 160 degrees of a single human's eye and about 200 degrees of both human's eyes which are considered to be a human's visual field, and show a 360-degree panorama space obtained by body and head movement. For example, by employing display means such as an organic EL or LCD for the user-dedicated device, a shape of the curved face can be formed, which can create a display similar to a face shape. This feature provides a sense of distance that is closest to eyes, thus solving a problem of conventional HMD (head mount display) projection distance. Moreover, combined use of a curved surface correction lens or a wide-angle lens can widen a view angle or brightness, producing highly accurate visual effects. Special filtering for the display above enables the system to render a three-dimensional picture for naked eyes to accurately reproduce the sense of distance.

In addition, the dedicated program software can prevent duplication and virus contamination, and protect copyright of a person who has prepared a program software, making it possible to easily and continually provide the sensory three-dimensional virtual real space system using dedicated program software with a secure security system. Viruses could spread fast when the program software is unified and shared between servers. For example, the installation program should be changed to a different type when package software and downloading software are used, and only a program which prevents the virus contamination from spreading can be used, such as a program having a virus checking program which restricts use of a program that cannot pass the virus checking program upon installing the downloaded program. Unifying the programs has conversely enabled the creation of conditions where protection can easily be made.

Moreover, the system above has features that it structures the three-dimensional virtual real space that can be life-size modules, which can be applied in various industries to maintain higher accuracy and safety in operations of remote-control machines. In addition, preliminary simulations can be made more accurately. In a security system, for example, dangerous objects or a suspicious person in a building can be recognized, and the three-dimensional scanning can make linkage with the three-dimensional real space, which enables a user to operate machines remotely. Work which must be done at a dangerous site can be made in the three-dimensional virtual real space instead, which eventually links the work in three-dimensional virtual real space with the work at a real work site. Such a feature can be realized because this system is a three-dimensional virtual real space system that enables constituting life-sized modules, enabling recognition of entire space regardless of the restriction on the field of view of camera work.

### BRIEF DESCRIPTION OF DRAWING

FIG. 1 is a basic system configuration diagram illustrating the best mode for carrying out the present invention.

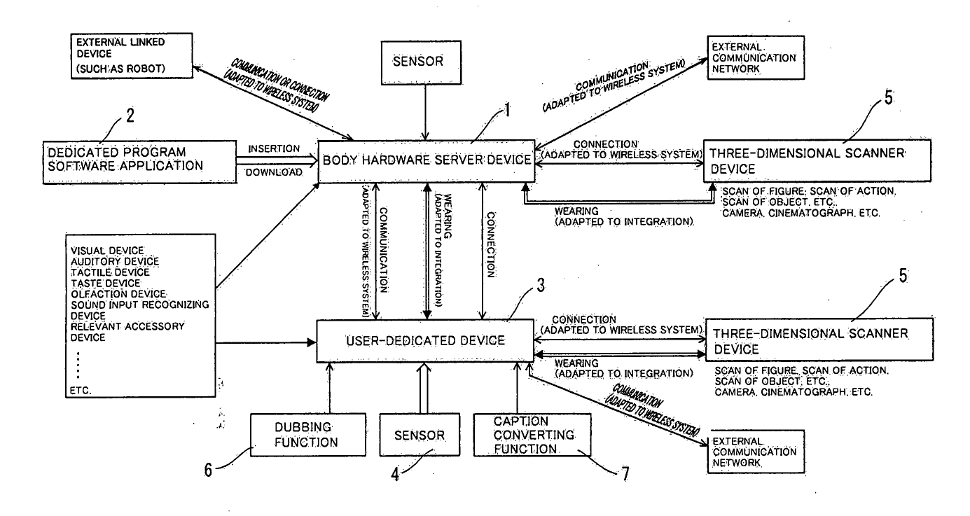

### EXPLANATION OF REFERENCE NUMERALS

1 Body hardware server device
2 Dedicated program software
3 User-dedicated device
4 Sensor
5 Three-dimensional scanner device
6 Dubbing function
7 Caption converting function

### BEST MODE FOR CARRYING OUT THE INVENTION

One of the preferable embodiments of the invention will be described below with reference to the drawing. A reference numeral 1 indicated in the drawing is a body hardware server device in the basic configuration of a sensory three-dimensional virtual real space system according to the present invention. The body hardware server device 1 has the Internet-connection capability and, upon insertion of a dedicated program software application 2 as an example of the standardized storage medium into the body hardware server device 1, a user can experience a space programmed in each piece of software.

As a medium through which a specific three-dimensional virtual real space is realized, the system is equipped with a user-dedicated device 3, which will be described later, in addition to the body hardware server device 1 and the dedicated program software application 2 described above. The body hardware server device 1 above reads the three-dimensional virtual real program upon insertion of the dedicated program software application 2, and by wirelessly connecting the body hardware server device 1 and the user-dedicated device 3 through, for example, a wireless communication method, the data is transmitted to the user side in real time, while the data corresponding to the user's various movements may be transmitted to the body hardware server device 1 as well.

The dedicated program software application 2 itself is packaged so that the duplication of data and virus contamination can be prevented, which also enables the copyright protection for the creator. That is, the dedicated program software application 2 as a storage medium that realizes such a three-dimensional virtual real space is designed based on the basic operation program in the dedicated program software application 2 in order to be applied to various fields of industries. The content of the software contributes to the creativity of the creator of a program of each field, for which reason it is designed to strictly protect the creator's rights including the copyright. More specifically, the dedicated program software application 2 includes, as an original packaged product, protection programs such as those for prohibiting copying or modification of the program.

Additionally, the system is equipped with the user-dedicated device 3 which includes devices that wirelessly react to the body hardware server device 1, such as a visual device, an auditory device, a tactile device, a taste device, a sound input recognition device, a relevant accessory device and a body-shape scanner that are specifically designed for the three-dimensional virtual real space. Anyone can enter the three-dimensional virtual real space simply by wearing the device, without the need for complicated conventional user terminals, etc. connected to the server through a network.

The user-dedicated device 3 can convert three-dimensionally converted data in the three-dimensional virtual real program into a four-dimensional time-space including up and down, left and right, front and back, and time, which can be constituted by real modules adapted to the user's figure and five senses and contains elements such as sounds, light, shadows on the program coordinate, and three-dimensional virtual real space is continuously variable according to the action of the user.

More specifically, all data in the three-dimensional virtual real space from the dedicated program software application 2 is converted into three-dimensional data. By enabling the wireless-type user-dedicated device 3 to generate a four-dimensional time-space panorama including up and down, left and right, front and back, and time, which can be constituted by four-dimensional sense (auditory sense, visual sense, and so on), the texture mapping for the three-dimensional concave-convex surface, instead of that for the two-dimensional surface, is possible when using the user-dedicated device 3. Thus, the system is constructed to facilitate the four-dimensional time-space experience with a feeling of distance.

In particular, elements such as sound, lights, and shadows are included on the three-dimensionally constructed numerous coordinates, and the user-dedicated device 3 converts them into the four-dimensional time-space panorama to reproduce it. Thus the user can perceive an object on his/her own back (on the back side), above, or below him/her based on his/her own viewpoint or auditory sense, etc. In addition, since it becomes equivalent to a real situation where the user feels objects, the user can experience the situation where the user feels a person coming toward him/her from behind before looking back to find a person standing.

Moreover, the user-dedicated device 3 is equipped with various sensors 4 relevant to the above-mentioned visual device, auditory device, tactile device, taste device, sound input recognition device, relevant accessory device which react wirelessly and a figure scanning device. The sensors 4 enable reading users' actions. Anyone can participate on the spot only by wearing the user-dedicated device 3, without the need for the dedicated code jack. In other words, the user-dedicated device 3 can also be equipped with multiple visual devices, auditory devices, tactile devices, taste devices, sound input recognition devices, relevant accessory devices and figure scanning devices since it works wirelessly, which enables multiple users to participate in the three-dimensional virtual real space.

The body hardware server device 1 or the user-dedicated device 3 can show almost the same viewing ranges as the ranges of about 160 degrees of a single human's eye and about 200 degrees of both human's eyes which are considered to be a human's visual field, and show a 360-degree panorama space obtained by movement of body, head and eyeball. In particular, by employing display means such as an organic EL or an LCD for the user-dedicated device 3, a shape of the curved face can be formed, which can create a display similar to a face shape. This feature provides a sense of distance that is closest to eyes, thus eliminating a problem of conventional HMD projection distance. Moreover, combined use of a curved surface correction lens and a wide-angle lens can widen an view angle, producing highly accurate visual effects. Special filtering for the display above enables the system to render a three-dimensional picture for naked eyes to accurately reproduce the sense of distance.

Specifically, since the three-dimensional virtual real space changes in accordance with actions such as movement of the eyeball or the face of a user and reacts to user's five senses and can be used continuously and dependently, the four-dimensional time space panorama is created by including the element of time in the space. More specifically, by using the dedicated program software application 2 inserted in the body hardware server device 1 and the wireless type user-dedicated device 3 concurrently, the distance to or the size of an object displayed in the three-dimensional virtual real space is constituted completely similar to the actual object, so that a user can grasp the state of the space in which the object is placed and additionally can determine how far he/she should stretch the hand to reach the object, how many steps he/she needs to get to the object, and how fast he/she should move, etc.

Moreover, in connection with the figure scanning device of the user-dedicated device 3, by using a three-dimensional scanner device 5 for the body hardware server device 1, for example, not only a virtual object or a virtual person but also an actual object or an actual person can appear in three-dimensional virtual real space. That is, it is also possible to contact with a virtual object or a virtual person in the three-dimensional virtual real space by showing a figure of a third party who is talking on the move in the three-dimensional virtual real space, which can be said to be the expansion version of the television-phone, etc. Moreover, the body hardware server device 1 or the user-dedicated device 3 can react to the sound of a user in the three-dimensional virtual real space. For example, the user can talk with a virtual person appeared in the three-dimensional virtual real space by using the sound input device of the above-mentioned user-dedicated device 3, and can wait for someone for a while in the three-dimensional virtual real space. At this time, since the three-dimensional virtual real space is the programmed space in the dedicated program software application 2, the auditory device or the sound input recognition device should be equipped with the dubbing function 6, or the visual device should be equipped with the caption converting function 7, to make the language used in the three-dimensional virtual real space correspond to the user's language so as to realize the virtual global communication.

Although an avatar is not exactly equal to a virtual person, an avatar can create an original character, which can be said to be other self of the avatar in the three-dimensional virtual real space and can move it inside the space by operating the avatar as a third person. On the other hand, a virtual person is defined as an original character in the three-dimensional virtual real space and can move as an A.I. program on a certain program.

Moreover, a user can arrange virtual furniture of the actual size freely and store objects in the furniture or use the objects virtually in the three-dimensional virtual real space. In addition, with the auditory device of the above-mentioned user-dedicated device 3, the realism such as sounds and conversations in the three-dimensional virtual real space can be easily grasped by realizing a sense of distance. For example, a user can watch TV (movies), listen to music or view websites by arranging a virtual personal computer, etc. as virtual goods, etc. in the three-dimensional virtual real space to use this three-dimensional data. The objects expressed in the whole three-dimensional virtual real space are programmed in advance. Since contents and prices, etc. of objects to be displayed can also be registered in advance, the user can check them as necessary, or even use them for advertisement to arouse consumers' interest.

The three-dimensional virtual real space is designed such that the three-dimensional data including virtual objects and virtual persons can be downloaded, transmitted and received to/from a third person using communication means such as broadband. At the same time, it is also possible to transfer from user's private three-dimensional virtual real space to a third person's private three-dimensional virtual real space. This can be achieved when their body hardware server devices 1 are connected with each other through an arbitrary communication network.

Additionally, purchase and sale of virtual immovable property, real immovable property, virtual goods and real goods, and dealing of virtual securities and real securities are made possible, and downloading music distribution data, image and video distribution data is also made possible. Moreover, electronic transactions through a virtual credit or virtual bank, etc. are also available. This enables persons engaged in various industries to make explanation of goods and price negotiation, etc. with the user through the broadband in the three-dimensional virtual real space. Such a three-dimensional virtual real space can be freely applied in response to various human beings, objects, shapes, environments, etc.

Furthermore, the system enables a communication equipment to be used as the body hardware server device 1, and the body hardware server device 1 or the user-dedicated device 3 can be used for fuel cells or in an in-house power generation system other than public power supply.

The above-mentioned structure makes issue of users' unique bank notes or securities possible as the users' virtual world and allows formation of laws (rules), thereby enabling users' three-dimensional virtual real space to form and create one world. This may establish unique dealings of exchange, etc., expand users' own three-dimensional virtual real space, and settle other users, in order to create a virtual nation.

Explaining how to use the present system, the dedicated program software application 2 is inserted into the body hardware server device 1 where the three-dimensional virtual real program is read. Then, a user wears the user-dedicated device 3, and connects the user-dedicated device 3 with the body hardware server device 1 through wireless communication, etc. In this way, data can be transmitted to the user side in real time, and the data corresponding to user's various actions may also be transmitted to the body hardware server device 1.

At this time, elements such as sound, lights, and shadows are included on the three-dimensionally constructed numerous coordinates, and the user-dedicated device 3 converts them into the four-dimensional time-space realistic panorama to reproduce it. All data in the three-dimensional virtual real space from the dedicated program software application 2 is converted into three-dimensional data. A four-dimensional time-space panorama including up and down, left and right, and front and back, which can be constituted by four-dimensional sense (auditory sense, visual sense and so on) is generated by the wireless-type user-dedicated device 3, and any user can enter the three-dimensional virtual real space simply by wearing the device.

Various sensors 4 relevant to the above-mentioned visual device, auditory device, tactile device, taste device, sound input recognition device, relevant accessory device which react wirelessly and the figure scanning device may read movement of the user. The three-dimensional virtual real space is changed continuously and dependently and reacts to human's five senses, etc. based on actions read in this way such as movement of user's eyeball or face, thus realizing the real panorama of the three-dimensional virtual real space which contains elements of time.

In addition, a virtual object and a virtual person as well as an actual object and an actual person can be shown in the three-dimensional virtual real space as necessary using the three-dimensional scanner device 5 of the body hardware server device 1 related to a body-shape scanning device of the user-dedicated device 3.

At this time, the auditory device or the sound input recognition device should be equipped with the dubbing function, or the visual device should be equipped with the caption converting function, to make the language used in the three-dimensional virtual real space correspond to the user's language so as to realize the virtual global communication.

The three-dimensional virtual-real-space is designed such that the three-dimensional data including virtual objects and virtual persons can be downloaded, transmitted and received to/from a third person using communication means such as broadband. At the same time, it is possible to transfer from user's private three-dimensional virtual real space to a third person's private three-dimensional virtual real space.

1. A sensory three-dimensional virtual real space system comprising:
a body hardware server device;
a three-dimensional virtual real program inserted or downloaded into the body hardware server device; and
a user-dedicated device which can be worn by, carried by, or installed near a user while integrally connected, wired, or wirelessly connected with the body hardware server device such that an operating range and degree of freedom increase to enable real-time recognition or transmission and reception, thus enabling the user to experience a three-dimensional virtual real space based on the three-dimensional virtual real program,
wherein the body hardware server device or the user-dedicated device can convert three-dimensionally converted data in the three-dimensional virtual real program into a four-dimensional time-space including up and down, left and right, front and back, and time, which can be constituted by real modules adapted to the user's figure and five senses and contains elements of five senses such as sounds, light, shadows, scent, gas, temperature and humidity in a program coordinate system, and the three-dimensional virtual real space is continuously variable according to the action of the user.

2. The sensory three-dimensional virtual real space system according to claim 1, wherein the body hardware server device or the user-dedicated device can configure and represent the three-dimensional virtual real space, which is exactly the same as the space of actual modules.

3. The sensory three-dimensional virtual real space system according to claim 1, wherein the body hardware server device or the user-dedicated device enables touch with real animals including human beings, virtual animals including human beings, real objects, and virtual objects including liquid, gas, particles, and quantum body in the virtual real space, and enables a user's viewpoint to change to a viewpoint of virtual animals including human beings, virtual objects including liquid, gas, particles, and quantum body, real animals including a life-sized human beings as a module, and real objects.

4. The sensory three-dimensional virtual real space system according to claim 1, wherein the body hardware server device or the user-dedicated device is provided with a three-dimensional scanner which can show the real animals and objects as life-sized modules other than the virtual animals and objects in the virtual real space, and can fetch scanned three-dimensional information in the virtual real space, and enables recognition of changes of movement and conditions as three-dimensional information in real time.

5. The sensory three-dimensional virtual real space system according to claim 1, wherein the body hardware server device or the user-dedicated device is provided with a communication unit that can transmit and receive three-dimensional data of the virtual animals and objects and information data between users.

6. The sensory three-dimensional virtual real space system according to claim 1, wherein the body hardware server device or the user-dedicated device is provided with a caption converting and displaying function, a function of voice synthesis program, etc. or a language dubbing function in order to match a language used in a three-dimensional virtual real space with a language used among users.

7. The sensory three-dimensional virtual real space system according to claim 1, wherein the body hardware server device or the user-dedicated device can respond to and operate with user operations through a voice or typing input in a three-dimensional virtual real space, is compatible with various authentication operations using vocal cord authentication in the three-dimensional virtual real space, and is provided with authentication functions including fingerprint and retina authentication using other dedicated devices when the voice authentication is unavailable, thus enabling various security countermeasures.

8. The sensory three-dimensional virtual real space system according to claim 1, wherein the body hardware server device or the user-dedicated device allows a plurality of users to participate in the three-dimensional virtual real space and to jointly own respective three-dimensional virtual real spaces owned by the plurality of users as a result of installation of these devices.

9. The sensory three-dimensional virtual real space system according to claim 1, wherein the body hardware server device or the user-dedicated device can be used as a mobile communication device and thus freely carried by a user, used anywhere in communication coverage areas, and can be integrated with each other so as to be formed in a handy shape as a unitary device and installed in a narrow space, thus enabling communication among users anywhere.

10. The sensory three-dimensional virtual real space system according to claim 1, wherein the body hardware server device or the user-dedicated device can be used in an in-house power generation system using power supply other than public power supply, photovoltaic generation or fuel cells, etc.

11. The sensory three-dimensional virtual real space system according to claim 1, wherein the body hardware server device or the user-dedicated device enables purchase and sale as well as dealing of virtual goods and various types of virtual data or rights such as virtual immovable properties in the three-dimensional virtual real space, enables purchase and sale as well as dealing of real data, rights and goods, etc., enables use of real currency and credits in various forms of dealing, and enables use of virtual currency or credits in a virtual bank, etc., and enables use of settlement in a legally authorized form, thus enabling settlement in the virtual real space unique to a user.

12. The sensory three-dimensional virtual real space system according to claim 1, wherein the body hardware server device or the user-dedicated device can show its viewing range which is the same as that of a human's view angle, thus enabling display of a 360-degree panorama space using movement of the body, head, and eyes.

13. The sensory three-dimensional virtual real space system according to claim 1, wherein the dedicated program as the three-dimensional virtual real program can prevent duplication and virus contamination, protect copyright of a person who has prepared a program software, and protect rights such as ownership of an owner of the three-dimensional virtual real program software.

14. The sensory three-dimensional virtual real space system according to claim 1, wherein the three-dimensional virtual real space can be structured as a life-sized module, and thus virtual actions can be linked with a real robot, etc. by replacing real material with that in virtual space, thereby enabling actions in the three-dimensional virtual real space to be directly linked with those in the real space.
